(19) United States
(12) Patent Application Publication
(10) Pub. No.: US 2015/0083796 A1
(43) Pub. Date: Mar. 26, 2015

(54) NFC OR RFID BASED SENSOR MEASUREMENT DEVICE AND MEASURING METHOD USING THE SAME

(71) Applicant: CENTER FOR INTEGRATED SMART SENSORS FOUNDATION, Daejeon (KR)

(72) Inventors: Chong-Min KYUNG, Daejeon (KR); Hyun Tae CHO, Daejeon (KR); Seung Ro LEE, Daejeon (KR)

(73) Assignee: CENTER FOR INTEGRATED SMART SENSORS FOUNDATION, Daejeon (KR)

(21) Appl. No.: 14/073,539

(22) Filed: Nov. 6, 2013

(30) Foreign Application Priority Data
Sep. 24, 2013 (KR) 10-2013-0113254

(51) Int. Cl. G06K 19/07; G06F 17/30; G06K 19/073

(52) U.S. Cl. CPC G06K 19/0723; G06K 19/073; G06F 17/30
USPC 235/375; 235/492

(57) ABSTRACT

Disclosed herein is a near field communication (NFC) or radio frequency identification (RFID) based sensor measurement device including: a sensor connecting part from or to which a sensor is detachable or attachable; and a sensor measuring part electrically connected to the sensor, wirelessly receiving power from an external electronic device, and measuring a sensed value to be measured using the sensor and then wirelessly transmitting the sensed value to the external electronic device. The sensor is detachable or attachable, such that only the sensor is replaced and the sensor measurement device may be continuously used without the replacement when the sensor used is disposable.

### CROSS REFERENCE TO RELATED APPLICATION

This application claims the benefit of Korean Patent Application No. 10-2013-0113254, filed on Sep. 24, 2013, entitled “NFC or RFID Based Sensor Measurement Device and Measuring Method Using the Same”, which is hereby incorporated by reference in its entirety into this application.

### BACKGROUND OF THE INVENTION

1. Technical Field

The present invention relates to a near field communication (NFC) or radio frequency identification (RFID) based sensor measurement device and a measuring method using the same, and more particularly, to an NFC or RFID based sensor measurement device which is communicated with a device capable of performing the NFC or RFID, that is, a smart device such as a smartphone, a smartpad, or the like, and has a variety of sensors detachable or attachable therefrom or thereto, and a measuring method using the same.

2. Description of the Related Art

Near field communication (NFC) and radio frequency identification (RFID) technologies are generally used to collect, store, process, and track corresponding information by attaching a tag to an object and wirelessly recognizing unique identification (ID) of the object using a reader. The NFC and RFID technologies are recently provided with a function that transmits unique identification information and measures a physical signal and a chemical signal by a sensor, such that an application area thereof has expanded.

As a related art measuring the physical signal and the chemical signal based on the NFC and RFID technologies, an NFC or RFID based electrochemical biosensor has been filed by the present inventor and has been disclosed in Patent Document 1.

FIG. 1 shows an NFC or RFID based electrochemical biosensor according to a related art. The NFC or RFID based electrochemical biosensor according to a related art is configured to include a sensor 1; an amplifier or a converter 2 amplifying or converting a signal received from the sensor 1; an analog to digital (A/D) converter 3 converting an analog signal to a digital signal; a processor 4 dating components measured by the sensor 1; an antenna 5 transmitting to and receiving from a smart device; a rectifier 6 receiving power from the smart device to generate necessary power; a signal sensing device 7 sensing a signal through the antenna 5; and a modulator and demodulator 8 modulating or demodulating the measured signal to a waveform suitable for transmitting, thereby making it possible to measure a specific component of a sample and check the measured component using the smart device.

However, the above-mentioned NFC or RFID based electrochemical biosensor according to a related art has the sensor and the tag integrated with each other. Therefore, in the case in which the sensor is disposable, the tag capable of being continuously used should also be discarded.

### RELATED ART DOCUMENT

### Patent Document

(Patent Document 1) Korean Patent Application No. 10-2013-0086035 (Jul. 22, 2013)

### SUMMARY OF THE INVENTION

An object of the present invention is to provide a near field communication (NFC) or radio frequency identification (RFID) based sensor measurement device capable of implementing the near field communication (NFC or RFID), detaching or attaching a sensor therefrom or thereto, and using various kinds of sensors, and a measuring method using the same.

According to an exemplary embodiment of the present invention, there is provided a near field communication (NFC) or radio frequency identification (RFID) based sensor measurement device, including: a sensor connecting part from or to which a sensor is detachable or attachable; and a sensor measuring part electrically connected to the sensor, wirelessly receiving power from an external electronic device, and measuring a sensed value to be measured using the sensor and then wirelessly transmitting the sensed value to the external electronic device.

According to another exemplary embodiment of the present invention, there is provided a measuring method using a near field communication (NFC) or radio frequency identification (RFID) based sensor measurement device, the method including: an operation of connecting a sensor connecting the sensor to the sensor connecting part of the near field communication or radio frequency identification based sensor measurement device; an approaching operation approaching an external electronic device to the NFC or RFID based sensor measurement device; an operation of starting measurement executing start instructions by the external electronic device; an operation of transmitting instructions supplying power and transmitting NFC instructions to the NFC or RFID based sensor measurement device by the external electronic device; an operation of generating power receiving the NFC instructions and generating the power by the NFC or RFID based sensor measurement device; an operation of recognizing instructions recognizing the NFC instructions and applying a voltage or a current to the sensor, by the NFC or RFID based sensor measurement device; an operation of converting a signal converting an analog signal to a digital signal by the NFC or RFID based sensor measurement device; a storing and transmitting operation storing the converted signal in a memory or transmitting the converted signal to the external electronic device, by the NFC or RFID based sensor measurement device; a receiving and displaying operation receiving the converted signal and displaying the converted signal using an embedded application, by the external electronic device; and a terminating operation turning off an NFC function of the external electronic device.

### BRIEF DESCRIPTION OF THE DRAWINGS

FIG. 1 is a configuration view of a near field (NFC) or radio frequency identification (RFID) based electrochemical biosensor according to the related art;

FIG. 2 shows an NFC or RFID based sensor measurement device according to an exemplary embodiment of the present invention;

FIG. 3 shows an NFC or RFID based sensor measurement device according to a first exemplary embodiment of the present invention;

FIG. 4 is a configuration view of an RF interface according to an exemplary embodiment of the present invention;

FIG. 5 shows an NFC or RFID based sensor measurement device according to a second exemplary embodiment of the present invention;

FIG. 6 shows an NFC or RFID based sensor measurement device according to a third exemplary embodiment of the present invention;

FIGS. 7A and 7B are use state views using a reader or a smart device; and

FIG. 8 is a flow chart of a measuring method using the NFC or RFID based sensor measurement device according to an exemplary embodiment of the present invention.

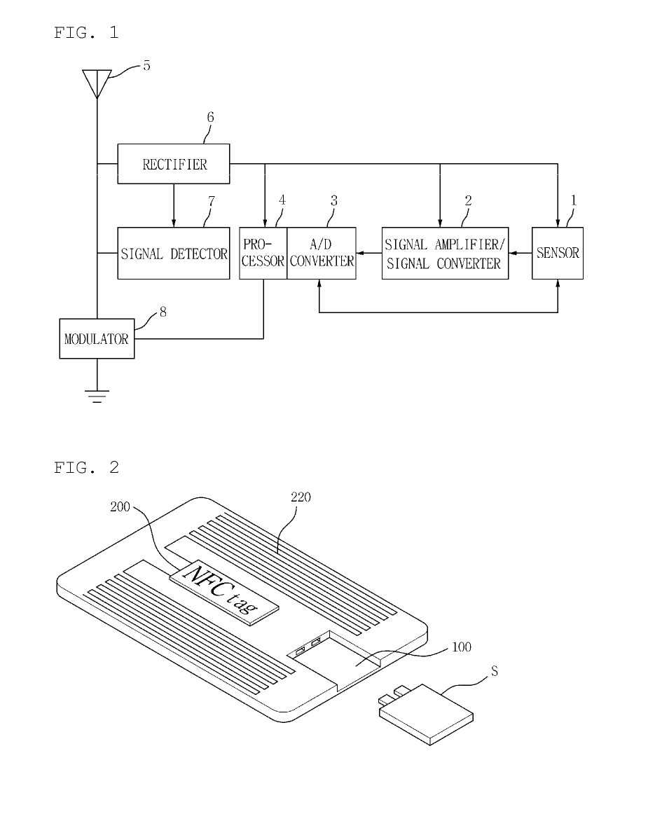

### DESCRIPTION OF THE PREFERRED EMBODIMENTS

Hereinafter, a near field communication (NFC) based sensor measurement device according to an exemplary embodiment of the present invention and a measuring method using the same will be described in detail with reference to the accompanying drawings.

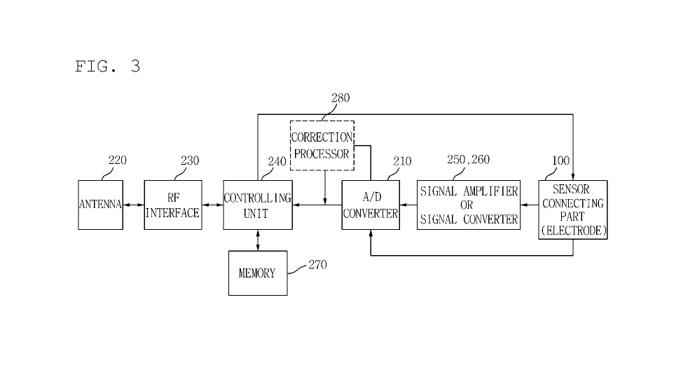

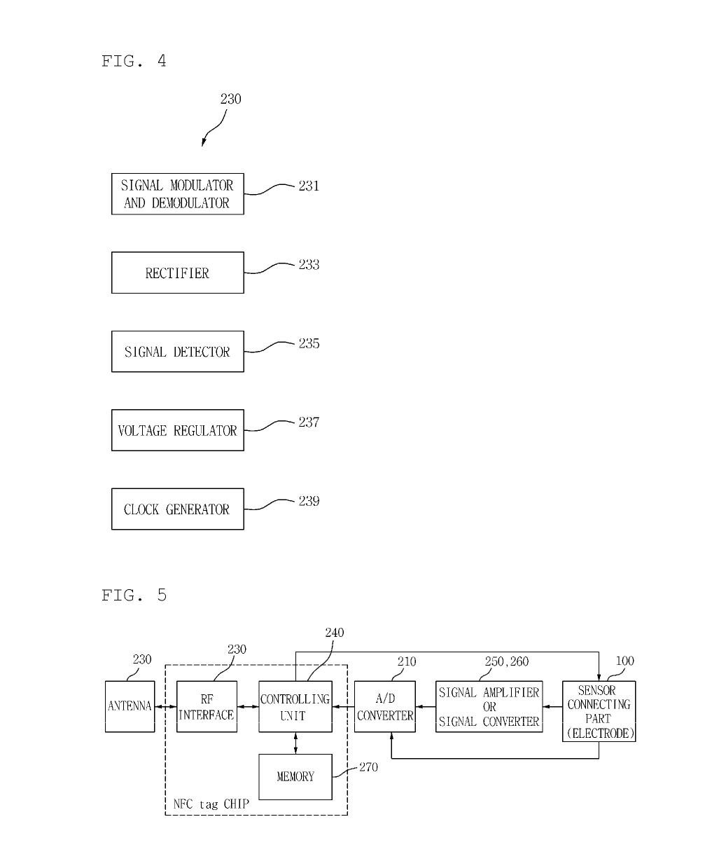

FIG. 2 shows an NFC or RFID based sensor measurement device according to an exemplary embodiment of the present invention, FIG. 3 shows an NFC or RFID based sensor measurement device according to a first exemplary embodiment of the present invention, and FIG. 4 is a configuration view of an RF interface according to an exemplary embodiment of the present invention.

The NFC or RFID based sensor measurement device according to the exemplary embodiment of the present invention is configured to include a sensor connecting part 100 from/to which a sensor S may be detached and attached and a sensor measuring part 200 electrically connected to the sensor S, wirelessly receiving power from an external electronic device, and measuring a sensed value to be measured using the sensor S and then wirelessly transmitting the value to the external electronic device. An example of the external electronic device may include a smart device or a reader. The external electronic device may be the smart device having a high supply rate and easy portability, and capable of installing an application suitable for the NFC or RFID based sensor measurement device according to the exemplary embodiment of the present invention.

A basic technical idea according to the present invention is to configure the NFC or RFID based sensor measurement device to allow the sensor S to be detached or attached therefrom or thereto as shown in FIG. 2 so that only the sensor S may be replaced in the case in which the sensor S used is disposable and the NFC or RFID based sensor measurement device may be continuously used without the replacement. In addition, since the sensor measuring part 200 may wirelessly receive power from the external electronic device using a scheme such as NFC, RFID, or the like and may transmit and receive data and instructions, the NFC or RFID based sensor measurement device according to the exemplary embodiment of the present invention may not include a separate battery.

The sensor connecting part 100, which is a terminal electrically connecting between the sensor S and the sensor measuring part 200, may be formed in a form that an electrode terminal is inserted or is in contact with. Since a typical biosensor has a configuration having a pair of measuring electrodes or a sample recognizing electrode (one sample recognizing electrode when one of the measuring electrodes is used as a common electrode and a pair of sample recognizing electrodes otherwise) in addition to the pair of measuring electrodes, the electrode terminal of the sensor connecting part 100 is formed to be two to four.

The sensor connecting part 100 is characterized by the sensor S configured to be detachable or attachable therefrom or thereto, and the sensor S should be able to measure at least a physical signal or a chemical signal.

Meanwhile, in a case of the disposable biosensor, the disposable biosensor has a defect that it should be discarded after being used just one time. In the NFC or RFID based sensor measurement device according to the exemplary embodiment of the present invention, the sensor connecting part 100 is configured to enable the detachment or attachment of the sensor S, such that only the sensor S used as the disposable is replaced and the NFC or RFID based sensor measurement device is continuously used without the replacement, thereby making it possible to solve the above-mentioned defect.

Describing an NFC based biosensor disclosed in Patent Document 1 filed by the present applicant as an example, the NFC based biosensor is relatively expensive and has a very small size, such that it is very difficult to design an antenna. In addition, in the case in which the biosensor measures blood, the biosensor has no choice but to be used as the disposable. In the case in which the NFC based biosensor used as the disposable as described above is integrated, portions capable of being continuously used except for the sensor are also used as the disposable and then discarded, such that costs may be seriously wasted.

Therefore, in the case in which the NFC or RFID based sensor measurement device is configured in a typical credit card form as shown in FIG. 2 to enable the sensor S to be separated therefrom, the NFC or RFID based sensor measurement device may be carried by putting into a purse such as the credit card and the like and may be used by replacing only the sensor S, thereby making it possible to decrease costs. In addition, the antenna 220 may have a large size, such that the antenna may be designed to obtain much gain.

In addition, when forming the NFC or RFID based sensor measurement device as a dongle, it may be utilized as the NFC sensor measurement device having a shape of accessories of a cellular phone or a key ring. In this case, the NFC or RFID based sensor measurement device according to the exemplary embodiment of the present invention may also serve as a security function.

The sensor measuring part 200, which is a component electrically connected to the sensor S through the sensor connecting part 100 to thereby measure a sensed value to be measured, process data, transmit and receive the data to and from an external electronic device, and receive power from the external electronic device, is configured to include an A/D converter 210 converting an analog signal received from the sensor connecting part 100 to a digital signal; an antenna 220 transmitting and receiving the data and power to and from the external electronic device; a radio frequency (RF) interface 230 sensing or modulating/demodulating the data or a control signal from the external electronic device received through the antenna 220; and a controlling unit 240 processing NFC instructions (instructions using the NFC or RFID) transmitted from the external electronic device. In this case, in order to allow the NFC or RFID based sensor measurement device according to the exemplary embodiment of the present invention to be used in various types of sensors S, the sensor measuring part 200 may be initialized or reconfigure its environment when the sensor S is electrically connected to the sensor connecting part 100. The initialization may include deletion of data stored in a memory, initialization of a program counter, or the like, and the environment reconfiguration may include selection of a data processing algorithm depending on a type of sensor S, a switching of a control mode such as an applied voltage, a measuring time, and the like, a switching of a data transmitting and receiving mode, and the like. The above-mentioned initialization or environment reconfiguration is performed according to a control of the controlling unit 240, but may be performed in a state in which separate components are added.

In addition, the sensor measuring part 200 is configured to further include a signal amplifier 250 amplifying a magnitude of the signal received from the sensor connecting part 100; a signal converter 260 converting the signal received from the sensor connecting part 100 into a signal suitable for processing in the controlling unit 240; an electrically programmable and erasable memory 270; and a correction processor 280 correcting the signal received from the sensor connecting part 100, thereby making it possible to smoothly perform the near field communication (NFC or RFID) with the external electronic device.

The A/D converter 210, which is a component converting an analog signal into a digital signal, is connected to the sensor connecting part 100 to convert the analog signal received from the sensor connecting part 100 to the digital signal and provide the converted digital signal to the controlling unit 240.

The antenna 220, which is a component capable of transmitting and receiving the data and power to and from the external electronic device such as the smart device, is formed in a shape having a predetermined pattern as shown in FIG. 2, for example. A detailed specification (for example, a wire, a width, a pattern, or the like) of the antenna 220 is changed depending on a frequency, an arrival distance, an energy transfer amount per time, or the like of the near field communication, and since this is a design item for a person skilled in the art, this may be used by appropriately designing depending on situations.

The RF interface 230, which is a component detecting and modulating/demodulating the signal received through the antenna 220, is connected to the antenna 220 and is configured to include a signal modulator and demodulator 231 and a rectifier 233.

The signal modulator and demodulator 231, which is a component for modulating the signal containing the measured data into a waveform suitable for transmission in order to transmit the measured data to the external electronic device, or demodulating the signal received from the external electronic device into a waveform suitable for a processing by the controlling unit 240, transfers the signal modulated into several bands according to a current near field communication standard to the antenna 220.

The rectifier 233 is a component generating the power necessary to drive the signal modulator and demodulator 231, the controlling unit 240, and the like by receiving the power from the external electronic device which is external to the NFC or RFID based sensor measurement device, since the NFC or RFID based sensor measurement device according to the exemplary embodiment of the present invention is a passive type without having a battery.

In addition, the RF interface 230 may further include a signal detector 235 detecting the signal from the external electronic device received through the antenna 220 to transfer it to the controlling unit 240 or the signal modulator and demodulator 231, a voltage regulator 237 providing appropriate voltage level and a clock generator 239 generating a clock to thereby supply the regulated voltage and the generated clock to the controlling unit 240. By the signal modulator and demodulator 231 and the signal detector 235, the near field communication between the near field communication based sensor measurement device according to the exemplary embodiment of the present invention and the external electronic device may be performed. The rectifier 233 and the voltage regulator 237 form a power generator.

Since a currently standardized NFC has a frequency band of 13.56 MHz and a maximum operation distance within 20 cm, and is generally used within 10 cm, the external electronic device needs to be approached to the NFC or RFID based sensor measurement device according to the exemplary embodiment of the present invention (in a case of RFID, the frequency band or the operation distance may be varied). When the external electronic device approaches the sensor measurement device, an electromagnetic induction phenomenon may be generated from the external electronic device to the antenna 220, where the rectifier 233 appropriately converts the power transferred by the above-mentioned electromagnetic induction and generates a necessary voltage to thereby supply them to internal elements.

The controlling unit 240, which is a component recognizing and processing NFC instructions transmitted from the external electronic device which is external to the NFC sensor measurement device, is connected to the RF interface 230 to thereby recognize the NFC instructions transmitted from the external electronic device through the antenna 220 and apply a current or voltage to the sensor S. Since the NFC or RFID based sensor measurement device according to the exemplary embodiment of the present invention is the passive type, it uses the power generated from the rectifier 233.

The signal amplifier 250, which is a component amplifying a magnitude of the signal, amplifies the signal when the signal transmitted from the sensor connecting part 100 is weak to thereby facilitate a signal processing. The signal amplifier may be omitted when the controlling unit 240 has good performance or the magnitude of the signal transmitted from the sensor connecting part 100 is sufficiently large.

The signal converter 260, which is a component converting the signal transmitted from the sensor connecting part 100 to a signal suitable for the processing by the controlling unit 240, may be a converter converting a current into a voltage, for example. Typically, since electronic elements mainly use a voltage value as an input, the signal converter 260 converting a current value into the voltage value is generally used, and includes integrated chips (ICs) such as an operational amplifier (OP AMP), for example. When the internal elements of the NFC or RFID based sensor measurement device according to the exemplary embodiment of the present invention are designed to process the current value, the signal converter 260 may be omitted. That is, in the case in which the current value is used as a sensor input, the voltage value may be obtained as a result, such that the signal converter 260 may be omitted.

The memory 270, which is a component storing data processed by the controlling unit 240, is connected to the controlling unit 240 and may be an electrically erasable and programmable read only memory (EEPROM). The EEPROM, which is a nonvolatile memory that may stably get back recorded data even when not powered, may electrically erase and re-record the recorded data as a variant of an erasable and programmable read only memory (EPROM). The data processed by the controlling unit 240 may be stored or transmitted to the external electronic device without requiring storing procedure, using the above-mentioned EEPROM. In the case in which the data processed by the controlling unit 240 does not need to be stored, the memory 270 may be omitted.

The sensor measuring part 200 may be configured to further include the correction processor 280, if necessary. The correction processor 280, which is a component correcting data measured by the sensor S among the digital signals transferred from the A/D converter 210, is connected to the A/D converter 210 to thereby correct the data measured by the sensor S and transfer the corrected data to the controlling unit 240. When using the correction processor 280, power consumption is increased while the data measured by the sensor S may be corrected by more precise and accurate operation. A design may be made so that the controlling unit 240 may process the above-mentioned data correction function.

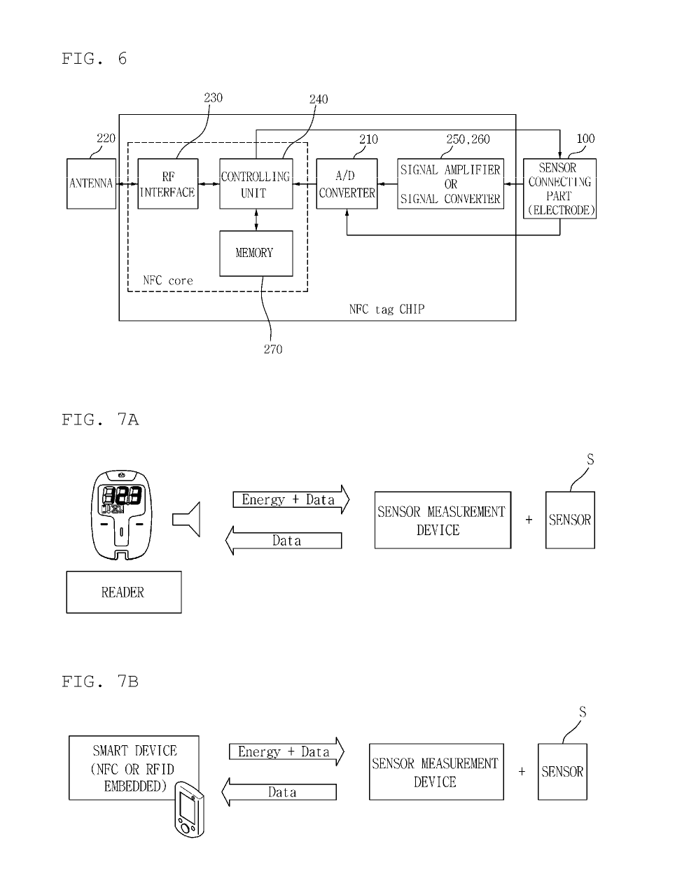

FIGS. 5 and 6 show NFC or RFID based sensor measurement devices according to another exemplary embodiment of the present invention. As shown in FIG. 5, an NFC tag chip including the RF interface 230, the controlling unit 240, and the memory 270 may be formed. In addition, as shown in FIG. 6, an NFC core including the RF interface 230, the controlling unit 240, and the memory 270 may be formed, and the NFC tag chip having the A/D converter 210, the signal amplifier 250, and the signal converter 260 coupled to the NFC core may be formed in a form of a system on chip (SoC).

FIGS. 7A and 7B are use state views using a reader or a smart device. As shown in FIG. 7A, a measured value may be displayed by the reader, or as shown in FIG. 7B, the measured value may be displayed by the smart device.

The smart device may be a smartphone, a PDA, a tablet PC, a notebook, or the like having an embedded NFC/RFID function.

The reader refers to a device capable of having the embedded NFC/RFID function to thereby communicate with the NFC or RFID sensor measurement device according to the exemplary embodiment of the present invention and reading the measured data, and a user who does not use the smart device is required to use the reader.

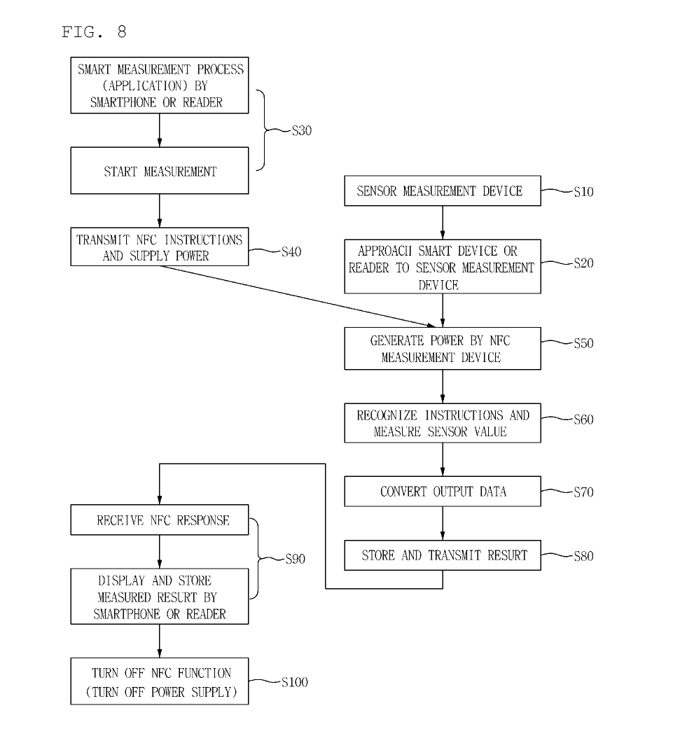

Next, a measuring method using the NFC or RFID based sensor measurement device according to the exemplary embodiment of the present invention will be described. FIG. 8 is a flow chart of a measuring method using the NFC or RFID based sensor measurement device according to an exemplary embodiment of the present invention.

\textcircled{1} An operation of connecting a sensor (S10): The sensor S is connected to the sensor connecting part 100 of the NFC or RFID based sensor measurement device using a method such as an insertion, or the like.

\textcircled{2} An approaching operation (S20): The external electronic device approaches the NFC or RFID based sensor measurement device according to the exemplary embodiment of the present invention.

\textcircled{3} An operation of starting a measurement (S30): As an operation executing start instructions by the external electronic device, for example, the start instruction may be executed by an application installed in the smart device or executed by pressing a button of the reader.

\textcircled{4} An operation of transmitting instructions (S40): The external electronic device supplies power and transmits NFC instructions to the NFC or RFID based sensor measurement device according to the exemplary embodiment of the present invention.

\textcircled{5} An operation of generating power (S50): The NFC or RFID based sensor measurement device according to the exemplary embodiment of the present invention receives the NFC instructions through the antenna 220 and generates the power at the rectifier 233.

\textcircled{6} An operation of recognizing the instructions (S60): The controlling unit 240 recognizes the NFC instructions and applies a voltage or current to the sensor S to thereby measure a sensor value.

\textcircled{7} An operation of converting a signal (S70): The A/D converter 210 converts an analog signal into a digital signal.

\textcircled{8} A storing and transmitting operation (S80): The converted signal is stored in the memory 270 or transmitted to the external electronic device through the antenna 220.

\textcircled{9} A receiving and displaying operation (S90): The external electronic device receives the converted signal and displays it using an embedded application.

\textcircled{10} A terminating operation (S100): An NFC function of the external electronic device is turned off to thereby stop the power supply and terminate the measurement of the sensor S.

The operation of starting the measurement (S30) and the operation of transmitting the instructions (S40) may be performed before the operation of connecting the sensor (S10). That is, before the sensor is connected to the sensor connecting part 100 and the NFC or RFID based sensor measurement device according to the exemplary embodiment of the present invention approaches the external electronic device, the start instructions may be executed through the external electronic device.

The NFC or RFID based sensor measurement device according to the present invention may implement the near field communication (NFC or RFID) to thereby measure data of the sensor by a smart device supporting the near field communication at anytime and anywhere, may replace only the sensor and continuously use the sensor measurement device without the replacement in the case in which the sensor used is disposable because the sensor is configured to be detached from the sensor measurement device to thereby decrease costs, and may use the various kinds of sensor to thereby have generality.

1. A near field communication (NFC) or radio frequency identification (RFID) based sensor measurement device, comprising:
a sensor connecting part from or to which a sensor is detachable or attachable; and
a sensor measuring part electrically connected to the sensor, wirelessly receiving power from an external electronic device, and measuring a sensed value to be measured using the sensor and then wirelessly transmitting the sensed value to the external electronic device.

2. The near field communication or radio frequency identification based sensor measurement device of claim 1, wherein the sensor measuring part is initialized when the sensor is electrically connected to the sensor connecting part.

3. The near field communication or radio frequency identification based sensor measurement device of claim 1, wherein the sensor measuring part reconfigures its environment when the sensor is electrically connected to the sensor connecting part.

4. The near field communication or radio frequency identification based sensor measurement device of claim 1, wherein the sensor measures a physical signal or a chemical signal.

5. The near field communication or radio frequency identification based sensor measurement device of claim 1, wherein the sensor measuring part performs NFC or RFID communications with the external electronic device.

6. The near field communication or radio frequency identification based sensor measurement device of claim 1, wherein the NFC or RFID based sensor measurement device has a credit card form.

7. The near field communication or radio frequency identification based sensor measurement device of claim 1, wherein the NFC or RFID based sensor measurement device has a dongle form.

8. The near field communication or radio frequency identification based sensor measurement device of claim 1, wherein the external electronic device is any one or more of a reader, a smartphone, a PDA, a tablet PC, and a notebook.

9. The near field communication or radio frequency identification based sensor measurement device of claim 1, wherein the sensor measuring part includes:
an analog to digital (A/D) converter connected to the sensor connecting part to thereby convert an analog signal received from the sensor connecting part to a digital signal;
an antenna transmitting and receiving data and power to and from the external electronic device;
a radio frequency (RF) interface sensing or modulating/demodulating the data or a control signal from the external electronic device received through the antenna; and
a controlling unit processing NFC instructions transmitted from the external electronic device.

10. The near field communication or radio frequency identification based sensor measurement device of claim 9, wherein the sensor measuring part further includes a signal amplifier connected to the sensor connecting part and amplifying a magnitude of the signal received from the sensor connecting part.

11. The near field communication or radio frequency identification based sensor measurement device of claim 9, wherein the sensor measuring part further includes a signal converter connected to the sensor connecting part and converting the signal received from the sensor connecting part to a signal suitable for a processing by the controlling unit.

12. The near field communication or radio frequency identification based sensor measurement device of claim 9, wherein the sensor measuring part further includes a memory connected to the controlling unit and which is electrically programmable and erasable.

13. The near field communication or radio frequency identification based sensor measurement device of claim 9, wherein the sensor measuring part further includes a correction processor connected to the controlling unit and correcting the signal received from the sensor connecting part.

14. The near field communication or radio frequency identification based sensor measurement device of claim 12, wherein an NFC tag chip including the RF interface, the controlling unit, and the memory is formed.

15. The near field communication or radio frequency identification based sensor measurement device of claim 12, wherein an NFC core including the RF interface, the controlling unit, and the memory is formed and an NFC tag chip having an A/D converter, a signal amplifier, and a signal converter coupled to the NFC core is formed in a form of a system on chip (SoC).

16. A measuring method using a near field communication (NFC) or radio frequency identification (RFID) based sensor measurement device, the method comprising:
an operation of connecting a sensor connecting the sensor to the sensor connecting part of the near field communication or radio frequency identification based sensor measurement device of claim 1;
an approaching operation approaching an external electronic device to the NFC or RFID based sensor measurement device;
an operation of starting measurement executing start instructions by the external electronic device;
an operation of transmitting instructions supplying power and transmitting NFC instructions to the NFC or RFID based sensor measurement device by the external electronic device;
an operation of generating power receiving the NFC instructions and generating the power by the NFC or RFID based sensor measurement device;
an operation of recognizing instructions recognizing the NFC instructions and applying a voltage or a current to the sensor, by the NFC or RFID based sensor measurement device;
an operation of converting a signal converting an analog signal to a digital signal by the NFC or RFID based sensor measurement device;
a storing and transmitting operation storing the converted signal in a memory or transmitting the converted signal to the external electronic device, by the NFC or RFID based sensor measurement device;
a receiving and displaying operation receiving the converted signal and displaying the converted signal using an embedded application, by the external electronic device; and
a terminating operation turning off an NFC function of the external electronic device.
